(19) United States
(12) Patent Application Publication
(10) Pub. No.: US 2007/0242840 A1
(43) Pub. Date: Oct. 18, 2007

(54) Condenser Microphone

(76) Inventor: Claus-Peter Hinke, Burgdorf (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/628,429

(22) PCT Filed: Jun. 3, 2005
(86) PCT No.: PCT/EP05/05971

§ 371 Date: May 10, 2007

(30) Foreign Application Priority Data
Jun. 3, 2004 (DE) 10 2004 027 110.0

(51) Int. Cl. H04R 19/00

(52) U.S. Cl. 381/174

(57) ABSTRACT

A microphone has a microphone capsule housing, a diaphragm, an electrode, and an insulating part which is arranged between the diaphragm and the electrode in the microphone capsule housing. The insulating part has a spacer ring.

### CROSS-REFERENCE TO RELATED APPLICATIONS

This application claims priority of International Application No. PCT/EP2005/005971, filed Jun. 3, 2005 and German Application No. 10 2004 027 110.0, filed Jun. 3, 2004, the complete disclosures of which are hereby incorporated by reference.

### BACKGROUND OF THE INVENTION

a) Field of the Invention

The present invention is directed to a microphone and to an insulating part for a microphone.

b) Description of the Related Art

Microphones are usually provided with microphone capsules which can have an electrode and a diaphragm. However, the electrode must be insulated from the diaphragm. Further, it is desirable that there is a defined distance between the diaphragm and electrode. Usually, an insulating part and a separate spacer ring are provided for this purpose, both of which are correspondingly arranged between the electrode and the diaphragm in the microphone capsule. The required spacer ring is typically stamped from foil; but this does not guarantee satisfactory cleaning of the spacer rings, because the cleaning liquid causes the spacer rings to adhere to one another so that dirt residues, among other things, cannot flow off satisfactorily.

In this regard, reference is had to DE 33 25 966 A1 and JP 2001008293 as prior art.

### OBJECT AND SUMMARY OF THE INVENTION

Therefore, it is the primary object of the present invention to provide a microphone with a microphone capsule which ensures trouble-free operation and an improved cleaning of all components.

This object is met by a microphone comprising a microphone capsule housing, a diaphragm, an electrode and an insulating part which is arranged between the diaphragm and the electrode in the microphone capsule housing. The insulated part has a spacer ring. The spacer ring is injection molded on the insulated part.

The invention is based on the idea of manufacturing an insulating part and a spacer ring in a microphone capsule as a single part in that the spacer ring, for example, is injection molded to the insulating ring.

Accordingly, a microphone with a microphone capsule housing, a diaphragm, an electrode, and an insulating part which is arranged between the diaphragm and the electrode in the microphone capsule housing is provided. The insulating part has a spacer ring.

Because the insulating part and the spacer ring are constructed as an individual element or part, only one element needs to be inserted into the microphone capsule instead of two elements, which results in a more efficient production process. Cleaning of the parts is likewise improved because there is no sticking together as a result of cleaning fluid.

According to an aspect of the present invention, the spacer ring is injection molded on the insulating part. This makes possible an economical and efficient production of the resulting combined part.

Further aspects of the present invention are indicated in the subclaims.

The invention will be described in more detail in the following with reference to the accompanying drawings.

### BRIEF DESCRIPTION OF THE DRAWINGS

In the drawings:

FIG. 1 shows a top view of an insulating part with spacer ring;

FIG. 2 shows a sectional view along section A-A of the insulating part from FIG. 1; and

FIG. 3 shows a larger sectional view Z of the section from FIG. 2.

### DESCRIPTION OF THE PREFERRED EMBODIMENTS

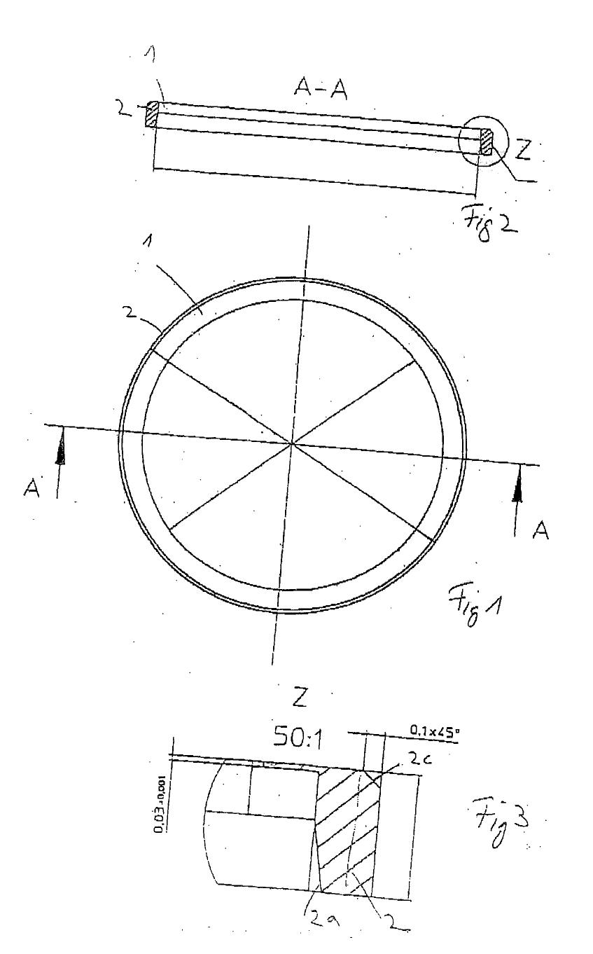

FIG. 1 is a top view showing an insulating ring 1 for insulating a diaphragm from an electrode in a microphone capsule housing. A spacer ring 2 is provided at the outer rim of the insulating ring. This spacer ring 2 serves to provide a defined distance between the diaphragm and the electrode. The spacer ring 2 is injection molded on the insulating ring 1 in an injection molding process. This injection molding process can be either a one-component injection molding process or a two-component injection molding process. When the spacer ring 2 is made from the same material as the insulating ring 1, a one-component injection molding process can be used. But when the spacer ring 2 is made from a different material than the insulating ring 1, a two-component injection molding process can be used.

FIG. 2 shows a sectional view along section A-A of the insulating ring in FIG. 1. It can be clearly seen that the spacer ring 2 has a greater thickness than the insulating ring 1.

FIG. 3 shows a partial sectional view Z of the section in FIG. 2. The shape and cross section of the spacer ring are shown in more detail. The spacer ring 2 has a first end 2c which has an inclination of preferably 45°. Further, the spacer ring 2 has another end 2a which faces the inside of the spacer ring.

Injection molding of the spacer ring 2 on the insulating ring 1 produces a new element that must be introduced for assembly in the microphone capsule. This is advantageous because now only one part is needed instead of two parts to ensure the insulation and the defined distance between the diaphragm and the electrode in the microphone capsule. Accordingly, the insulating ring 1 with the spacer ring 2 can be stacked in a microphone capsule housing automatically. Both automatic stacking and manual stacking are considerably facilitated in this way and the corresponding costs are reduced.

The spacer ring can have a thickness of 30 μm, for example. However, this thickness may vary according to the desired application and microphone capsule.

While the foregoing description and drawings represent the present invention, it will be obvious to those skilled in the art that various changes may be made therein without departing from the true spirit and scope of the present invention.

What is claimed is:

1-2. (canceled)

3. A microphone comprising:
a microphone capsule housing;
a diaphragm;
an electrode; and
an insulating part which is arranged between the diaphragm and the electrode in the microphone capsule housing;
said insulating part having a spacer ring, said spacer ring being is injection molded on the insulating part.

4. An insulating part for a microphone for insulating a diaphragm and an electrode in a microphone capsule housing of the microphone, comprising:
a spacer ring, said spacer ring being injection molded on the insulating part.
